(19) United States
(12) Patent Application Publication
(10) Pub. No.: US 2023/0344252 A1
(43) Pub. Date: Oct. 26, 2023

(54) SYSTEMS AND METHODS FOR CONTACT SELF-PROTECTION FOR AUTOMATIC SWIMMING POOL CLEANER

(71) Applicant: ZODIAC POOL CARE EUROPE, Belberaud (FR)

(72) Inventors: Louis Favié, Colomiers (FR); Arnaud Lancry, Le Vernet (FR)

(73) Assignee: ZODIAC POOL CARE EUROPE, Belberaud (FR)

(21) Appl. No.: 18/126,182

(22) Filed: Mar. 24, 2023

Related U.S. Application Data
(60) Provisional application No. 63/325,008, filed on Mar. 29, 2022.

(51) Int. Cl. H02J 7/00; E04H 4/16; B60L 53/16

(52) U.S. Cl. CPC H02J 7/0042; B60L 53/16; E04H 4/1654; B60L 2200/40

(57) ABSTRACT

A charging system for an automatic swimming pool cleaner (APC) includes one or more electrical contacts and a protection system that selectively prevents access to and/or or allows contact with the one or more electrical contacts. In some cases, the protection system may selectively clean the one or more electrical contacts. In certain cases, the protection system may prevent access to and/or allow contact with the one or more electrical contacts based on a position of the APC.

### REFERENCE TO RELATED APPLICATION

This application claims the benefit of U.S. Provisional Pat. Application No. 63/325,008, filed on Mar. 29, 2022, and entitled SYSTEMS AND METHODS FOR CONTACT SELF-PROTECTION FOR AUTOMATIC SWIMMING POOL CLEANER, the content of which is incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs) with electrical contacts.

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Certain APCs, particularly those with on-board power sources such as on-board batteries, periodically may need to charge or recharge themselves. Such charging typically includes the use of electrical contacts on the APC that contact corresponding electrical contacts of a charging system such as a charging station, charging dock, or charging trolley. Electrical contacts on an APC and/or charging system may be susceptible to damage, corrosion, surface deterioration, and chemical deposits. Such contacts may also provide an unwanted visual appearance and/or be a potential source of injury to a user (e.g., due to inadvertent contact).

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a charging system for an APC includes an electrical contact and a protection system to selectively prevent or allow contact with the electrical contact. The electrical contact with the protection system may be on a charging station and/or the APC

According to various embodiments, a self-protection mechanism for an electrical contact of an APC is configured to expose or shield the electrical contact in response to the APC being received by or removed from a charging station.

According to some embodiments, a self-protection mechanism for an electrical contact of charging station is configured to expose or shield the electrical contact in response to the charging station receiving or surrendering an APC

According to certain embodiments, a cleaning mechanism for an electrical contact of an APC is configured to clean the electrical contact in response to the APC being received by or removed from a charging station.

According to various embodiments, a cleaning mechanism for an electrical contact of a charging station is configured to clean the electrical contact in response to the charging station receiving or surrendering an APC.

According to some embodiments, a method of articulating a self-protection mechanism of an APC for exposing or shielding an electrical contact of the APC includes positioning the APC onto or removing the APC from a charging station.

According to certain embodiments, a method of articulating a cleaning mechanism of an APC for cleaning an electrical contact of the APC includes positioning the APC onto or removing the APC from a charging station.

According to various embodiments, a charging system for an APC includes an electrical contact and a protection system configured to selectively clean the electrical contact.

According to certain embodiments, a charging system for an APC comprises an electrical contact and a protection system for the electrical contact that covers or exposes the electrical contact based on a position of the APC.

### BRIEF DESCRIPTION OF THE DRAWINGS

The specification makes reference to the following appended figures, in which use of like reference numerals in different figures is intended to illustrate like or analogous components.

FIG. 1 illustrates an APC and a charging system according to embodiments.

FIG. 2 illustrates a portion of the charging system of FIG. 1 with a protection system according to embodiments.

FIG. 3 illustrates another portion of a charging system with a protection system according to embodiments and with an electrical contact in an uncovered position.

FIG. 4 illustrates the charging system of FIG. 3 with the electrical contact in a covered position.

### DETAILED DESCRIPTION

Described herein are systems and methods for protecting electrical contacts for use with an APC. Such electrical contacts may be on the APC itself and/or on a charging station, and the protection systems may thus be provided on the APC and/or on the charging station. The systems and methods provided herein may include a protective cover that selectively covers or moves away from the electrical contacts. In certain embodiments, the systems and methods provided herein may include various self-protection mechanisms that may automatically protect the electrical contacts without human interaction. Such systems and methods may prevent or minimize damage to the electrical contacts, clean the contacts from dust and/or surface deterioration, visually hide the electrical contacts when not in use, and/or provide improved safety, among other benefits. In certain embodiments, the systems and methods provided herein may provide a visual indication that may reassure a user seeing electrical contacts in a pool or water environment. Various other benefits and advantages may be realized with the systems and methods described herein, and the aforementioned benefits and advantages should not be considered limiting.

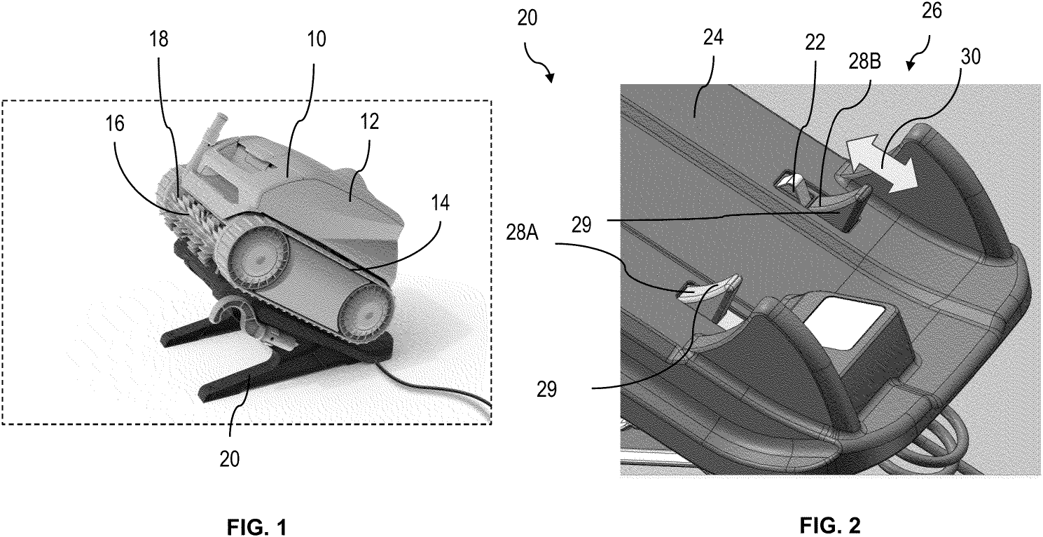

FIG. 1 illustrates a charging system 21 with an APC 10 and a charging station 20 according to embodiments. The APC 10 generally includes a body 12, one or more motive elements 14, and one or more cleaning devices 16 (including but not limited to a scrubber brush 18). A motor, pump, filter, and various other features may be provided on or within the APC 10 as desired. Non-limiting examples of APCs 10 may include those described in U.S. Pat. No. 10,316,534, U.S. Pat. No. 9,488,154, U.S. Pat. No. 8,578,538, and U.S. Pat. Publication No. 2014/0303810, all of which are hereby incorporated by reference in their entireties. The APC 10 may include one or more electrical contacts for contacting corresponding electrical contacts 22 of the charging station 20.

Referring to FIG. 2, the charging station 20 generally includes a base or dock 24 with one or more electrical contacts 22. In the embodiment illustrated, the charging station 20 includes two electrical contacts 22. In certain embodiments, the charging station 20 includes a protection system 26 with a one or more protective covers 28. While the protection system 16 is illustrated with the charging station 10, in other embodiments, it may be provided on an APC 10, on a trolley, and/or on other devices associated with the APC 10 and/or with electrical contacts as desired.

The protection system 26 includes one or more protective covers 28, and in the embodiment of FIG. 1 the protection system 26 includes two protective covers 28A-B. The protective covers 28 may be constructed from various materials as desired. In certain embodiments, the protective covers 28 are constructed from non-conductive materials.

In some embodiments, the protective covers 28 of the protection system 26 may be a self-protection mechanism that automatically covers and/or prevents contact with the electrical contacts 22 when not in use. In FIG. 2, protective cover 28A is in a covered position (and is covering a corresponding electrical contact) and protective cover 28B is in an uncovered position relative to the electrical contact 22.

The protective covers 28 may be movable relative to the electrical contacts 22 using various techniques or mechanisms as desired between the covered position and the uncovered position relative to the electrical contacts 22. The protective covers 18 may be configured for various types of movement relative to the electrical contacts 22. Non-limiting examples of movement by the protective covers 28 may include, but are not limited to, linear movement (e.g., translation or sliding of the protective covers 28), rotation of the protective covers 28, combinations thereof, and/or other types of movements or combinations of movements as desired. In the embodiment illustrated, the protective covers 28 are slidable (represented by arrow 30) between a covered position and an uncovered position.

In some embodiments, the protection system 26 may include actuators or other mechanisms or devices for actively moving the electrical contacts between the covered and uncovered positions. As examples, the protection system 26 may articulate to expose or shield the electrical contacts 22 by electrical and/or mechanical means. Examples of actuation for moving the protective covers 28 between covered and uncovered positions include, but are not limited to, spring actuation, actuation by electrical motor, or actuation by a lock and key mechanism. Other examples are also possible.

In certain embodiments, the APC 10 on the charging station 20 may automatically move the protective covers 28 from the covered position to the uncovered position (e.g., due to gravity). In such examples, the protection system 26 may expose the electrical contacts 22 when the charging station 20 receives the APC 10. The self-protection mechanism may be constructed so that reception and/or removal of the APC 10 by and/or from the charging station 10 provides sufficient signaling and/or energy to articulate the self-protection mechanism. In the embodiment illustrated in FIG. 2, the protective covers 28 include projected portions 29 that may be engaged by the APC 10 and/or by a user as desired to move the protective covers 28 to the covered position and/or uncovered position. Optionally, the projected portions 29 may include an arcuate and/or non-linear surface to improve contact between the APC 10 and the protective covers 28. In other embodiments, the projected portions 29 may be omitted, and the protective covers 28 need not include such projected portions 29. As a non-limiting example, in other embodiments, the protective covers 28 may be generally planar or flat, and/or have other shapes or profiles as desired.

Optionally, the protection system 26 includes a biasing mechanism (e.g., spring, elastic member, and/or other suitable device) that biases the protective covers 28 to the covered position. Optionally, in the covered position, the protective covers 28 may seal the electrical contacts 22.

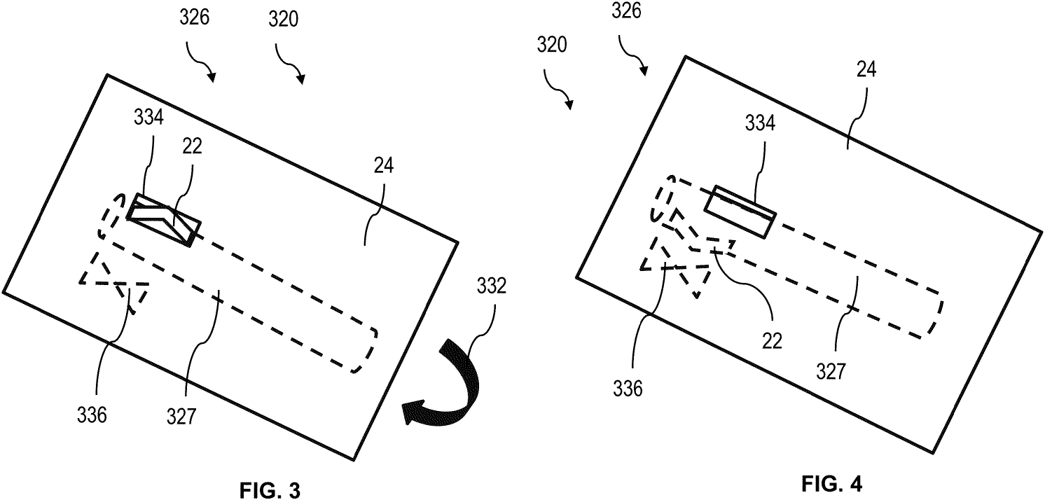

The particular shape and/or profile of the protective covers 28 should not be considered limiting, and in other embodiments, the protection system 26 may include protective covers 28 with other shapes and/or profiles as desired. In other embodiments, the protection system 26 may include other devices or features for selectively allowing or preventing contact with the electrical contacts 22. Other non-limiting examples of self-protection mechanisms of the protection system 26 may include, but are not limited to, a door that selectively shields the electrical contacts 22, a feature internal to the APC that orients the electrical contacts into a sealed position internal to the APC (e.g., via rotation and/or as otherwise desired), and/or any type of cap capable of sealing the electrical contact. As a non-limiting example, FIGS. 3 and 4 illustrate a portion of another charging station 320 with a protection system 326 with a rotating member 327 that rotates (represented by arrow 332) the electrical contact 22 between an uncovered position (FIG. 3) and a covered position (FIG. 4). In the uncovered position, the electrical contact 22 is in alignment with and extends partially through an opening 334 in the base 24, while in the covered position, the electrical contact 22 is rotated out of alignment with the opening 334. Other examples are also possible, and the aforementioned examples should not be considered limiting.

Optionally, and as illustrated in FIGS. 3 and 4, the protection system 26 may include various devices, mechanisms, or features for cleaning, drying, and/or otherwise treating the electrical contacts 22 to maintain the life of the electrical contacts 22. A non-limiting example may include a cleaning device 336 such as not limited to a brush, scrubber, bristles, sponge, cleaning pad, and/or cleaning devices as desired oriented to contact and clean the electrical contact 22 as the electrical contact 22 rotates to face into the base 24 of the charging station 20. Another example may include brushes and/or other cleaning features on the protective covers 28 that clean the electrical contacts 22 as the protective covers 28 translate (or otherwise move) relative to the electrical contacts 22. As a non-limiting example, a cleaning device may be provided on a surface of the protective cover 28 that faces and/or translates over the electrical contact 22. Other cleaning devices or mechanisms may be used and with various components of the protective system as desired.

In certain embodiments, the protection systems described herein may provide the device with electrical contacts 22 (i.e., the APC, the charging station 20, the trolley, etc.) with an enhanced aesthetic by shielding the electrical contacts 22 when not in use. The self-protection mechanism of the protection system may reduce or prevent an electrical shock hazard. The-self-protection mechanism may also assuage an end-user’s concerns related to the lifespan of the APC 10, concerns about the aesthetics of the APC 10, and/or concerns about a shock hazard.

Exemplary concepts or combinations of features of the invention may include:

A. A charging system for an APC comprising an electrical contact and a protection system configured to selectively prevent or allow contact with the electrical contact.

B. The charging system of any preceding or subsequent statement or combination of statements, wherein the protection system comprises a protective cover.

C. The charging system of any preceding or subsequent statement or combination of statements, wherein the protective cover comprises a projection portion with a surface configured to engage the APC.

D. The charging system of any preceding or subsequent statement or combination of statements, wherein the protective cover is movable between a covered position and an uncovered position relative to the electrical contact.

E. The charging system of any preceding or subsequent statement or combination of statements, wherein the protective cover is biased towards the covered position.

F. The charging system of any preceding or subsequent statement or combination of statements, wherein the protection system is actuated.

G. The charging system of any preceding or subsequent statement or combination of statements, wherein the protection system comprises a rotating member.

H. The charging system of any preceding or subsequent statement or combination of statements, further comprising a cleaning device configured to selectively clean the electrical contact.

I. The charging system of any preceding or subsequent statement or combination of statements, wherein the protection system is on a charging station of the charging system.

J. The charging system of any preceding or subsequent statement or combination of statements, wherein the protection system is on the APC.

K. A self-protection mechanism for an electrical contact of an APC, configured to expose or shield the electrical contact in response to the APC being received by or removed from a charging station.

L. A self-protection mechanism for an electrical contact of charging station, configured to expose or shield the electrical contact in response to the charging station receiving or surrendering an APC.

M. A cleaning mechanism for an electrical contact of an APC, configured to clean the electrical contact in response to the APC being received by or removed from a charging station.

N. A cleaning mechanism for an electrical contact of a charging station, configured to clean the electrical contact in response to the charging station receiving or surrendering an APC.

O. A method of articulating a self-protection mechanism of an APC for exposing or shielding an electrical contact of the APC by positioning the APC onto or removing the APC from a charging station.

P. A method of articulating a cleaning mechanism of an APC for cleaning an electrical contact of the APC by positioning the APC onto or removing the APC from a charging station.

Q. A charging system for an APC comprises an electrical contact and a protection system configured to selectively clean the electrical contact.

R. The charging system of any preceding or subsequent statement or combination of statements, further comprising the APC, and wherein the protection system is on the charging station or the APC.

S. The charging system of any preceding or subsequent statement or combination of statements, further comprising a charging station comprising a base, wherein the protection system comprises a cleaning device recessed into the base for selectively cleaning the electrical contact.

T. The charging system of any preceding or subsequent statement or combination of statements, wherein the protection system comprises a protective cover, and wherein a cleaning device is on the protective cover for selectively cleaning the electrical contact.

U. A charging system for an APC comprises an electrical contact and a protection system for the electrical contact that covers or exposes the electrical contact based on a position of the APC.

V. The charging system of any preceding or subsequent statement or combination of statements, wherein the protection system is configured to cover the electrical contact based on an absence of the APC and expose the electrical contact based on a presence of the APC.

W. The charging system of any preceding or subsequent statement or combination of statements, wherein the protection system comprises a protective cover movable between a covered position in which the protective cover covers the electrical contact and an uncovered position in which the electrical contact is exposed.

X. The charging system of any preceding or subsequent statement or combination of statements, wherein the protective cover is biased to the covered position.

Y. The charging system of any preceding or subsequent statement or combination of statements, wherein the protection system is configured to clean the electrical contact in response to the APC being received by or removed from a charging station.

Z. The charging system of any preceding or subsequent statement or combination of statements, further comprising a charging station, and wherein the electrical contact and protection system are on the charging station.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12″ and any one of which may be referred to generically as a device “12”. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A charging system for an automatic swimming pool cleaner (APC) comprises an electrical contact and a protection system configured to selectively prevent or allow contact with the electrical contact.

2. The charging system of claim 1, wherein the protection system comprises a protective cover.

3. The charging system of claim 2, wherein the protective cover comprises a projection portion with a surface configured to engage the APC.

4. The charging system of claim 2, wherein the protective cover is movable between a covered position and an uncovered position relative to the electrical contact.

5. The charging system of claim 4, wherein the protective cover is biased towards the covered position.

6. The charging system of claim 1, wherein the protection system is actuated.

7. The charging system of claim 1, wherein the protection system comprises a rotating member.

8. The charging system of claim 1, further comprising a cleaning device configured to selectively clean the electrical contact.

9. The charging system of claim 1, wherein the protection system is on a charging station of the charging system.

10. The charging system of claim 1, wherein the protection system is on the APC.

11. A charging system for an automatic swimming pool cleaner (APC) comprises an electrical contact and a protection system configured to selectively clean the electrical contact.

12. The charging system of claim 11, further comprising the APC, and wherein the protection system is on the APC.

13. The charging system of claim 11, further comprising a charging station comprising a base, wherein the protection system comprises a cleaning device recessed into the base for selectively cleaning the electrical contact.

14. The charging system of claim 11, wherein the protection system comprises a protective cover, and wherein a cleaning device is on the protective cover for selectively cleaning the electrical contact.

15. A charging system for an automatic swimming pool cleaner (APC) comprises an electrical contact and a protection system for the electrical contact that covers or exposes the electrical contact based on a position of the APC.

16. The charging system of claim 15, wherein the protection system is configured to cover the electrical contact based on an absence of the APC and expose the electrical contact based on a presence of the APC.

17. The charging system of claim 15, wherein the protection system comprises a protective cover movable between a covered position in which the protective cover covers the electrical contact and an uncovered position in which the electrical contact is exposed.

18. The charging system of claim 17, wherein the protective cover is biased to the covered position.

19. The charging system of claim 15, wherein the protection system is configured to clean the electrical contact in response to the APC being received by or removed from a charging station.

20. The charging system of claim 15, further comprising a charging station, and wherein the electrical contact and protection system are on the charging station.
